(19) United States
(12) Patent Application Publication
(10) Pub. No.: US 2020/0034620 A1
(43) Pub. Date: Jan. 30, 2020

(54) SELF-RELIANT AUTONOMOUS MOBILE PLATFORM

(71) Applicant: NEU ROBOTICS, INC., Weatherford, TX (US)

(72) Inventor: Cyril Lutterodt, Weatherford, TX (US)

(21) Appl. No.: 16/323,507

(22) PCT Filed: Aug. 5, 2017
(86) PCT No.: PCT/US2017/045649

§ 371 Date: Oct. 16, 2019

Related U.S. Application Data
(60) Provisional application No. 62/371,695, filed on Aug. 5, 2016.

(51) Int. Cl. G06K 9/00; B64C 39/02; G01C 11/28; G01C 11/10; G05D 1/10; G06K 9/62; G06T 7/73

(52) U.S. Cl. CPC G06K 9/00671; B64C 39/024; G01C 11/28; G01C 11/10; B64C 2201/123; G06K 9/6288; G06T 7/74; G06K 9/0063; B64C 2201/127; G05D 1/104

(57) ABSTRACT

A drone (105) and a method for stitching video data in three dimensions. The method comprises generating video data, localizing and mapping the video data, generating a three-dimensional stitched map, and wirelessly transmitting data for the stitched map. The data is generated using at least one camera (225) mounted on a drone (105), and includes multiple viewpoints of objects in an area. The data, including the multiple viewpoints, is localized and mapped by at least one processor (210) on the drone. The three-dimensional stitched map of the area is generated using the localized and mapped video data. The data for the stitched map is wirelessly transmitted by a transceiver (220) on the drone.

### CROSS-REFERENCE TO RELATED APPLICATIONS

This application is a 371 National Stage of International Application No. PCT/US2017/045649 filed Aug. 5, 2017, which claims priority to U.S. Provisional Patent Application No. 62/371,695 filed Aug. 5, 2016, the disclosures of which are herein incorporated by reference in their entirety.

### TECHNICAL FIELD

The present disclosure relates generally to mobile platform navigation. More particularly, the present disclosure relates to a self-reliant autonomous mobile platform.

### BACKGROUND

Autonomous mobile platforms are becoming increasingly common. They are of particular use to law enforcement and military personnel, who utilize them for reconnaissance and to map specific areas. Given the importance of the work for which autonomous mobile platforms are utilized, it is imperative they be as precise and time efficient as possible. Current solutions fail to provide law enforcement and military personnel with autonomous mobile platforms that are self-reliant and capable of stitching together one or more three-dimensional maps of a given area in real time.

Accordingly, it would be advantageous to have systems and methods that take into account one or more of the issues discussed above, as well as possibly other issues.

### SUMMARY

The different illustrative embodiments of the present disclosure provide a method for using the self-reliant autonomous mobile platform for stitching video data in three dimensions.

In one embodiment, a method for stitching video data in three dimensions is provided. The method comprises generating video data, localizing and mapping the video data, generating a three-dimensional stitched map, and wirelessly transmitting data for the stitched map. The data is generated using at least one camera mounted on a drone, and includes multiple viewpoints of objects in an area. The data, including the multiple viewpoints, is localized and mapped by at least one processor on the drone. The three-dimensional stitched map of the area is generated using the localized and mapped video data. The data for the stitched map is wirelessly transmitted by a transceiver on the drone.

In another embodiment, a drone is provided. The drone includes a camera, at least one processor, and a transceiver. The camera is configured to generate video data, including multiple viewpoints of objects in an area. The at least one processor is operably connected to the camera. The at least one processor is configured to localize and map the video data, including the multiple viewpoints. The at least one processor is further configured to generate a three-dimensional stitched map of the area using the localized and mapped video data. The transceiver is operably connected to the at least one processor. The transceiver is configured to wirelessly transmit data for the stitched map.

In various embodiments, the at least one processor is configured to generate video data based on received path planning data, localize and map the video data, including the multiple viewpoints by identifying objects in the video data, compare the objects to object image data stored in a database identify a type of the object based on the comparison, and include information about the object in the map proximate the identified object. In some embodiments, the at least one processor is further configured to generate a three-dimensional stitched map of the area using the localized and mapped video data, and compress the data for the stitched map. In some embodiments, the transceiver is configured to receive path planning from the server and wirelessly transmit the compressed data for the stitched map. In some embodiments, the drone may be one of a plurality of drones. If the drone is one of a plurality of drones, the at least one processor is further configured to identify other drones and a location of the other drones relative to the drone by comparing images of the other drones from the generated video data to images of other drones stored in the database, monitor the location of other drones relative to the drone, control a motor of the drone to practice obstacle avoidance, and include and dynamically update the location of the other drones in the local map transmitted to the server.

In another embodiment, an apparatus for a server is provided. The server comprises a transceiver and a processor. The processor is configured to determine an area to be mapped, generate paths for one or more drones, stitch together multiple local maps generated by the drones to create a global map, determine if any parts of the map are missing or incomplete, regenerate paths for the drones if parts of the map are missing or incomplete, and compress the stitched map data for transmission. The transceiver is configured to transmit the paths to the drones, receive the local maps from the drones, and transmit the global map to a client device.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIG. 2A illustrates a block diagram of components included in a mobile platform in accordance with various embodiments of the present disclosure;

FIG. 2B illustrates a block diagram of an example of a server in which various embodiments of the present disclosure may be implemented;

FIG. 3 illustrates an object/facial recognition system according to various embodiments of the present disclosure;

FIG. 4 illustrates a three-dimensional object deep learning module according to various embodiments of the present disclosure;

FIG. 5 illustrates a three-dimensional facial deep learning module according to various embodiments of the present disclosure;

FIG. 6 illustrates a navigation/mapping system according to various embodiments of the present disclosure;

FIG. 7 illustrates an example process for generating a three-dimensional stitched map of an area according to various embodiments of the present disclosure;

FIG. 8 illustrates an example process for object recognition according to various embodiments of the present disclosure; and

FIG. 9 illustrates an example process for swarming according to various embodiments of the present disclosure.

### DETAILED DESCRIPTION

The various figures and embodiments used to describe the principles of the present disclosure in this patent document are by way of illustration only and should not be construed in any way to limit the scope of the present disclosure. Those skilled in the art will understand that the principles of the present disclosure may be implemented in any type of suitably-arranged device or system.

Autonomous navigation for mobile platforms include but are not limited to unmanned land vehicles, unmanned aerial vehicles, unmanned water vehicles, and unmanned underwater vehicles. Embodiments of the present disclosure provide methods that are used to train a data set for autonomous navigation for mobile platforms that provide improved safety features while following traffic regulations such as, for example, air-traffic regulations.

Embodiments of the present disclosure provide an unsupervised, self-annealing navigation framework system for mobile platforms. By using deep learning combined with web-sourced multimedia tagging frameworks using databases such as, for example, Google Image search and Facebook™ reverse face tracking, the system can enhance object and scenery recognition. The mobile platform can use this object and scenery recognition for localization where other modalities, such as, for example, GPS, fail to provide sufficient accuracy. The system further provides optimization for both offline and online recognition.

By utilizing artificial intelligence (AI) techniques to perform non-trivial tasks such as localization, navigation, and decision making, lower-cost components and sensors can be used for the mobile platform, such as, for example, a Microsoft Kinect RGB-Depth (RGB-D) sensor compared to a more expensive three-dimensional LIDAR, such as, for example, Velodyne LIDAR. Embodiments of the present disclosure can also combine multiple types of modalities, such as, for example, RGB-D sensors, ultrasonic sonars, GPS, and inertial measurement units.

Various embodiments of the present disclosure provide a software framework that autonomously detects and calibrates controls for typical and more-advanced flight models such as of those with thrust vectoring (e.g., motors that can tilt).

Various embodiments of the present disclosure recognize that a deliberate navigation framework for mobile platforms relies on knowing the navigation plan before the tasks are initiated, which is reliable but may be slower because of the time it takes to calculate adjustments. Various embodiments of the present disclosure also recognize that a reactive navigation framework for mobile platforms solely relies on real-time sensor feedback and does not rely on planning for control. Consequently, embodiments of the present disclosure provide for efficient combination of both to achieve reactive yet deliberate behavior.

In certain embodiments, when an obstacle, for example a human, is detected, safety protocols are invoked, the navigation framework of the present disclosure provides controls for the mobile platform to keep clearance distances to avoid collision and monitor behavior of other objects in the environment, the mobile platform may move slower to identify better readings of environment, and the mobile platform may alert operator(s) of safety issues.

Various embodiments of the present disclosure utilize custom-tailored, dedicated DSP's (digital signal processors) that preprocess the extrinsic sensory data, such as, for example, imagery and sound data, to more efficiently use the available onboard data communication bandwidths. For example, in various embodiments, the DSPs may perform preprocessing, such as, for example, Canny edge, extended Kalman filter (EKF), simultaneous localization and mapping (SLAM), histogram of oriented gradient (HOG), principal component analysis scale-invariant feature transformation (PCA-SIFT), which provides local descriptors that are more distinctive than a standard SIFT algorithm, etc., before passing reduced, but still effective, information to the main processor.

In various embodiments, the mobile platform includes a coprocessor dedicated to controlling separate functions such as controlling motors, analyzing inertial measurement unit (IMU) readings and real time kinematic (RTK) GPS data. In these embodiments, the mobile platform uses the main processor for image detection and recognition and obstacle detection and avoidance through thresholding and Eigenfaces. The main processor is also dedicated to point-cloud processing data and sending the data to the cloud for tagging and storage.

Various embodiments of the present disclosure utilize a point cloud library (PCL) to enable processing of large collections of three-dimensional data and as a medium for real-time processing of three-dimensional sensory data in general. This software utilized by the mobile platform 105 allows for advanced handling and processing three-dimensional data for three-dimensional computer vision.

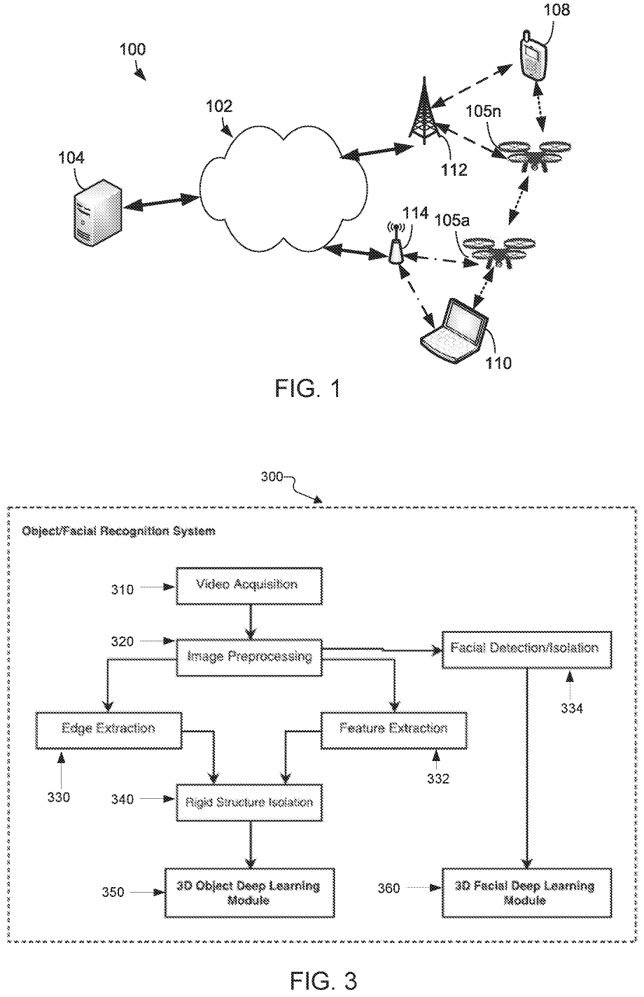

FIG. 1 illustrates an example communication system 100 in which various embodiments of the present disclosure may be implemented. The embodiment of the communication system 100 shown in FIG. 1 is for illustration only. Other embodiments of the communication system 100 could be used without departing from the scope of this disclosure.

As shown in FIG. 1, the system 100 includes a network 102, which facilitates communication between various components of the system 100. For example, the network 102 may communicate Internet Protocol (IP) packets, frame relay frames, or other information between network addresses. The network 102 may include one or more local area networks (LANs), metropolitan area networks (MANs), wide area networks (WANs), all or a portion of a global network, such as the Internet; or any other communication system or systems at one or more locations.

The network 102 facilitates communications between at least one server 104 and various client devices 105-114. Each server 104 includes any suitable computing or processing device that can provide computing services for one or more client devices. Each server 104 could, for example, include one or more processing devices, one or more memories storing instructions and data, and one or more network interfaces facilitating communication over the network 102. For example, one or more of the servers 104 may contain a database of images for object recognition.

Each client device 105-110 represents any suitable computing or processing device that interacts with at least one server or other computing device(s) over the network 102. In this example, the client devices 105-110 include electronic devices, such as, for example, a mobile platform 105, a mobile telephone or smartphone 108, a personal computer 112, etc. However, any other or additional client devices could be used in the communication system 100.

In this example, some client devices 105-110 communicate indirectly with the network 102. For example, the client devices 105-110 may communicate with the network 102 via one or more base stations 112, such as cellular base stations or eNodeBs, or one or more wireless access points 114, such as IEEE 802.11 wireless access points. These examples are for illustration only. In some embodiments, each client device could communicate directly with the network 102 (e.g., via wireline or optical link) or indirectly with the network 102 via any suitable intermediate device(s) or network(s).

In certain embodiments, the system 100 may utilize a mesh network for communications. Re-routing communications through nearby peers/mobile platforms can help reduce power usage as compared to directly communicating with a base station (e.g., one of client devices 108 and 110, the server 104, or any other device in the system 100). Also, by using a mesh network, transmissions can be ad hoc through the nearest mobile platform 105a-n to feed data when signal is down for transmission. The mesh network provides a local area network low frequency communication link to give the exact location of the mobile platform, the intended location, and the task at hand.

In certain embodiments, for high level control, the mobile platform 105 may send data with the structure of the message as event, task, and location information to another device (e.g., to a peer mobile platform 105a-n, one of the client devices 108 or 110, or the server 104). The event information shows whether the mobile platform 105 is flying, driving, using propulsion, etc. The task information describes what task the mobile platform 105 is assigned to accomplish e.g., servicing devices in hazardous environments, picking up an object or dropping off a package, etc. The location information discloses the current location with a destination.

In certain embodiments, the mobile platform 105 uses stream ciphers to encrypt and authenticate messages between a base station (e.g., one of client devices 108 and 110, the server 104, or any other device in the system 100) and the mobile platform 105 in real time. The stream ciphers are robust in that the loss of a few network packets won't affect future packets. One or more objects in the communication system 100 also try to detect and record any suspicious packets and report them for security auditing.

In a preferred embodiment, the mobile platform 105 is an unmanned aerial vehicle (UAV), such as, a drone, with a vertical take-off and landing (VTOL) design with adaptable maneuvering capabilities. In some embodiments, the UAV has an H-bridge frame instead of an X frame, allowing a better camera angle and stabilized video footage. The arms of the UAV lock for flight and are foldable for portability. The UAV has VTOL capabilities in that the motors 215 can turn the blades 45 degrees facing the front of the UAV. This configuration may be used for long distance travel as the UAV is now fixed wing and the back two motors 215 become redundant and may be turned off to preserve power. Upon getting to a building or close quarters the motors can be tilted back to the original position. This configuration allows the UAV to use all four motors 215 to perform aggressive maneuvers.

As described in more detail below, the mobile platform 105 includes a navigation framework that allows the mobile platform 105 to be autonomous through the use of obstacle detection and avoidance. For example, the mobile platform 105 may communicate with the server 104 to perform obstacle detection, with another of the client devices 105-110 to receive commands or provide information, or with another of the mobile platforms 105a-105n to perform coordinated or swarm navigation. In various embodiments, mobile platform 105 is an aerial drone. However, mobile platform 105 may be any vehicle that may be suitably controlled to be autonomous or semi-autonomous using the navigation framework described herein. For example, without limitation, mobile platform 105 may also be a robot, a car, a boat, a submarine, or any other type of aerial, land, water, or underwater vehicle.

Although FIG. 1 illustrates one example of a communication system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

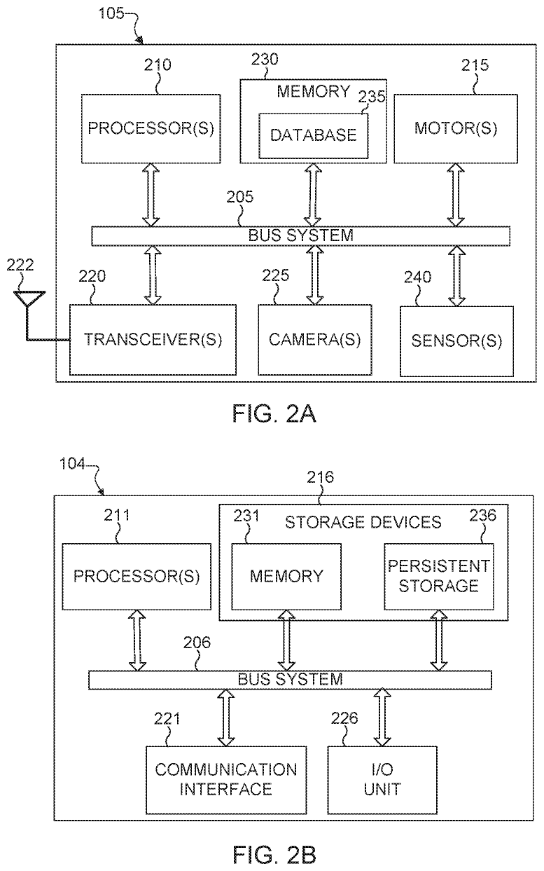

FIG. 2A illustrates a block diagram of components included in mobile platform 105 in accordance with various embodiments of the present disclosure. The embodiment of the mobile platform 105 shown in FIG. 2A is for illustration only. Other embodiments of the mobile platform 105 could be used without departing from the scope of this disclosure.

As shown in FIG. 2A, the components included in the mobile platform 105 is an electronic device that includes a bus system 205, which supports connections and/or communication between processor(s) 210, motor(s) 215, transceiver(s) 220, camera(s) 225, memory 230, and sensor(s) 240.

The processor(s) 210 executes instructions that may be loaded into a memory 230. The processor(s) 210 may include any suitable number(s) and type(s) of processors or other devices in any suitable arrangement. Example types of processor(s) 210 include microprocessors, microcontrollers, DSPs, field programmable gate arrays, application specific integrated circuits, and discreet circuitry. The processor(s) 210 may be a general-purpose central processing unit (CPU) or specific purpose processor. For example, in some embodiments, processor(s) 210 include a general-purpose CPU for obstacle detection and platform control as well as a co-processor for controlling the motor(s) 215 and processing positioning and orientation data.

The memory 230 represents any structure(s) capable of storing and facilitating retrieval of information (such as data, program code, and/or other suitable information on a temporary or permanent basis). The memory 230 may represent a random access memory or any other suitable volatile or non-volatile storage device(s), including, for example, a read-only memory, hard drive, or Flash memory.

The transceiver(s) 220 supports communications with other systems or devices. For example, the transceiver(s) 220 could include a wireless transceiver that facilitates wireless communications over the network 102 using one or more antennas 222. The transceiver(s) 220 may support communications through any suitable wireless communication scheme including for example, Bluetooth, near-field communication (NFC), WiFi, and/or cellular communication schemes.

The camera(s) 225 may be one or more of any type of camera including, without limitation, three-dimensional cameras or sensors, as discussed in greater below. The sensor(s) 240 may include various sensors for sensing the environment around the mobile platform 105. For example, without limitation, the sensor(s) 240 may include one or more of a gyroscope or gyro sensor, an air pressure sensor, a magnetic sensor or magnetometer, an acceleration sensor or accelerometer, a proximity sensor, IMU, LIDAR, RADAR, GPS, depth sensor, etc. The motor 215 provides propulsion and handling for mobile platform 105. For example, without limitation, the motor 215 may be a rotary motor, a jet engine, a turbo jet, a combustion engine, etc.

The mobile platform 105 collects extrinsic and intrinsic sensor data using sensor(s) 240, for example, inertial measurement, RGB video, GPS, LIDAR, range finders, sonar, and three-dimensional camera data. A low-power general, central processor (e.g., processor(s) 210) processes the combined data input of commands, localization, and mapping to perform hybrid deliberative/reactive obstacle avoidance as well as autonomous navigation through the use of multimodal path planning. The mobile platform 105 includes custom hardware odometry, GPS and IMU (i.e. acceleration, rotation, etc.) to provide improved positioning, orientation, and movement readings. For example, custom camera sensors use light-field technology to accurately capture three-dimensional readings as well custom DSP to provide enhanced image quality.

In certain embodiments the mobile platform 105 performs various processes to provide autonomy and navigation features. Upon powering on, the mobile platform 105 runs an automatic script that calibrates the mobile platform's orientation by being placed on a flat surface through the IMU. The mobile platform 105 requests the GPS coordinates of the device's current position. The mobile platform 105 localizes the position and scans the surrounding area for nearby obstacles to determine whether it is safe to move/takeoff. Once the safety procedure is initialized the mobile platform 105 may process the event, task, and location. The mobile platform 105 processes a navigation algorithm that sets a waypoint for the end location. The event is initiated to estimate the best possible mode of transportation to the end location. To perform the task, the mobile platform 105 uses inverse kinematics to calculate the best solution for once at the location to solve the task. After the task is complete, the mobile platform 105 can return ‘home’ which is the base location of the assigned mobile platform.

FIG. 2B illustrates a block diagram of an example of the server 104 in which various embodiments of the present disclosure may be implemented. As shown in FIG. 2B, the server 104 includes a bus system 206, which supports communication between processor(s) 211, storage devices 216, communication interface 221, and input/output (I/O) unit 226. The processor(s) 211 executes instructions that may be loaded into a memory 231. The processor(s) 211 may include any suitable number(s) and type(s) of processors or other devices in any suitable arrangement. Example types of processor(s) 211 include microprocessors, microcontrollers, digital signal processors, field programmable gate arrays, application specific integrated circuits, and discreet circuitry. For example, in some embodiments, the processor(s) 211 may support and provide path planning for video mapping by the mobile platform 105 as discussed in greater detail below.

The memory 231 and a persistent storage 236 are examples of storage devices 216, which represent any structure(s) capable of storing and facilitating retrieval of information (such as data, program code, and/or other suitable information on a temporary or permanent basis). The memory 231 may represent a random access memory or any other suitable volatile or non-volatile storage device(s). The persistent storage 236 may contain one or more components or devices supporting longer-term storage of data, such as a read-only memory, hard drive, Flash memory, or optical disc. For example, in some embodiments, persistent storage 236 may store or have access to one or more databases of image data for object recognition as discussed herein.

The communication interface 221 supports communications with other systems or devices. For example, the communication interface 221 could include a network interface card or a wireless transceiver facilitating communications over the network 102. The communication interface 221 may support communications through any suitable physical or wireless communication link(s). For example, in some embodiments, the communication interface 221 may receive and stream map data to various client devices. The I/O unit 226 allows for input and output of data. For example, the I/O unit 226 may provide a connection for user input through a keyboard, mouse, keypad, touchscreen, or other suitable input device. The I/O unit 226 may also send output to a display, printer, or other suitable output device.

Although FIG. 2B illustrates one example of a server 104, various changes may be made to FIG. 2B. For example, various components in FIG. 2B could be combined, further subdivided, or omitted and additional components could be added according to particular needs. As a particular example, while depicted as one system, the server 104 may include multiple server systems that may be remotely located.

Various embodiments of the present disclosure provide dynamic performance optimization. The mobile platform 105 optimizes data transmission using software controlled throttling to control which data gets priority. For example, if the wireless transmission becomes weak, the mobile platform 105 can choose to deprioritize video data in favor of operational commands, status, and basic location/orientation.

In certain embodiments, the mobile platform 105 may utilize path planning. For example, by using a combination of path planning algorithms, the mobile platform 105 may receive the current imagery feeds and convert the feeds into density maps. The mobile platform 105 duplicates the image to apply Canny Edge algorithm and overlays a vanishing line through the use of Hough lines. This gives the mobile platform 105 perspective as a reference point. Example path planning algorithms are further described in “An accurate and robust visual-compass algorithm for robot mounted omnidirectional cameras,” Robotics and Autonomous Systems, by Mariottini, et al. 2012 which is incorporated by reference herein in its entirety. This reference point is stored into a database which is later used for localization of the platform 105. Optical flow tracks the motion of objects which is used to predict the location of an object's motion. In addition, the mobile platform 105 detects and tracks additional features which could extraneous shapes like corners or edges.

In certain embodiments, the mobile platform 105 may use a HOG pedestrian detector to avoid humans. A HOG pedestrian detector is a vision based detector that uses non-overlap histograms of an oriented gradient appearance descriptor. Example pedestrian detection techniques are further described in “Pedestrian detection: A benchmark,” CVPR by Dollar, et al. 2009 which is incorporated by reference herein in its entirety. Although FIG. 2A illustrates one example of a mobile platform 105, various changes may be made to FIG. 2A. For example, the mobile platform 105 could include any number of each component in any suitable arrangement.

FIG. 2B illustrates a block diagram of components included in server 104 in accordance with various embodiments of the present disclosure. The embodiment of the server 104 shown in FIG. 2B is for illustration only. Other embodiments of the server 104 could be used without departing from the scope of this disclosure. As shown in FIG. 2, the server 104 includes a bus system 206, which supports communication between at least one processor(s) 211, at least one storage device 216, at least one transceiver 221, and at least one input/output (I/O) interface 226.

The processor(s) 211 executes instructions that may be loaded onto a memory 231. The processor(s) 211 may include any suitable number(s) and type(s) of processors or other devices in any suitable arrangement. Example types of processor(s) 211 include, without limitation, microprocessors, microcontrollers, digital signal processors, field programmable gate arrays, application specific integrated circuits, and discreet circuitry.

The memory 231 and a persistent storage 236 are examples of storage devices 216, which represent any structure(s) capable of storing and facilitating retrieval of information (such as data, program code, and/or other suitable information on a temporary or permanent basis). The memory 231 may represent a random access memory or any other suitable volatile or non-volatile storage device(s). The persistent storage 236 may contain one or more components or devices supporting longer-term storage of data, such as a ready only memory, hard drive, Flash memory, or optical disc.

The communication interface 221 supports communications with other systems or devices. For example, the communication interface 221 could include a network interface card or a wireless transceiver facilitating communications over the network 102. The communication interface 221 may support communications through any suitable physical or wireless communication link(s). The I/O interface 245 allows for input and output of data. For example, the I/O interface 245 may provide a connection for user input through a keyboard, mouse, keypad, touchscreen, or other suitable input device. The I/O interface 245 may also send output to a display, printer, or other suitable output device. Although FIG. 2B illustrates one example of components of a server 104, various changes may be made to FIG. 2B. For example, the server 104 could include any number of each component in any suitable arrangement.

FIG. 3 illustrates an object/facial recognition system 300 in accordance with an embodiment of the present disclosure. For example, the system 300 by be implemented by the mobile platform 105 and/or the server 104. The embodiment of the object/facial recognition system 300 shown in FIG. 3 is for illustration only. Other embodiments of the object/facial recognition system 300 could be used without departing from the scope of this disclosure.

Ordinarily, to perform enhanced image and object recognition, large datasets and an exorbitant amount of supervised machine learning may be needed to achieve significant accuracy. To avoid excessive effort of maintaining such a learning system, as each new object or image would need to be tuned, certain embodiments of the mobile platform 105 may utilize deep learning processes. Deep learning processes allow for unsupervised learning and tuning of the image/object/facial recognition system by automating the high-level feature and data extraction.

In operation 310, the mobile platform 105 acquires video data utilizing the one or more cameras 225 and/or one or more sensors 240 described above. In operation 320, the images from the video data are preprocessed. In certain embodiments, the system 300 can automatically tune the image/object/face recognition performed in combination with a crowdsourced database, such as, for example through Google'™ reverse image search or a Facebook™ profile search (deep face). The results from the tuned system are then applied on the three-dimensional imagery data (or datasets) that was collected from the camera 225 and/or sensors 240 to perform advanced image/object recognition. At this level, objects may be recognized at different angles and accuracy enhanced with scenery context.

In operation 330, system 300 performs edge extraction upon a preprocessed image from operation 320. By extracting the edges of an image, the image can be passed on for further processing. The edge is detected by the collection of the surrounding pixels having a step edge, which can be seen through the intensity of the image. In certain embodiments, the mobile platform 105 may use a Canny edge, which allows important features to be extracted, such as corners and lines. The exact edge location is determined by smoothing and sharpening the noise, calculating the gradient magnitude, and applying thresholding to determine which pixels should be retained and which pixels should be discarded. Edges are invariant to brightness.

In operation 332, system 300 performs feature extraction upon a preprocessed image from operation 320. To apply feature extraction, the mobile terminal isolates the surface of the image and matches regions to local features. These feature descriptors are calculated by the eigenvectors of a matrix. The matrix is of every pixel on the screen which is processed as the multiple points intersect. These features consist of edges, corners, ridges, and blobs. In certain embodiments, a Harris operator is used to enhance the feature extraction technique as it is invariant to translation and rotation.

In operation 334, the system 300 performs facial detection and isolation by using one or more aspects of module 400 described in greater detail below. In certain embodiments, the mobile platform 105 detects an image frame by calculating the distance between the two eyes, mouth, width of the nose, and length of the jaw line. This image is then compared to the face template for frontal, 45°, and profile views to verify if it is a valid face. In certain embodiments, skin tone may be used in addition to find segments. The skin tone color statistics are very distinctive and may be analyzed to determine if the image is a face. In certain embodiments, the YCbCr color space may be used as most effective for detecting faces.

In operation 340, the system 300 performs rigid structure isolation. Rigid structure isolation incorporates the results of edge extraction 330 and feature extraction 332 to identify images of specific objects captured in the acquired video 310. In certain embodiments, each isolated object is categorized as an individual image, which can then be processed.

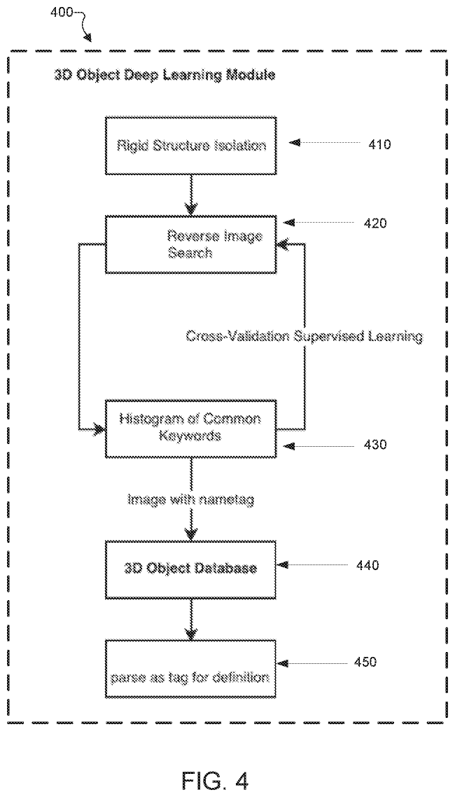

In operation 350, the system 300 utilizes a three-dimensional object deep learning module, for example the three-dimensional object deep learning module 400 shown in FIG. 4 below. An example of the three-dimensional object deep-learning module 400 is described in greater detail below.

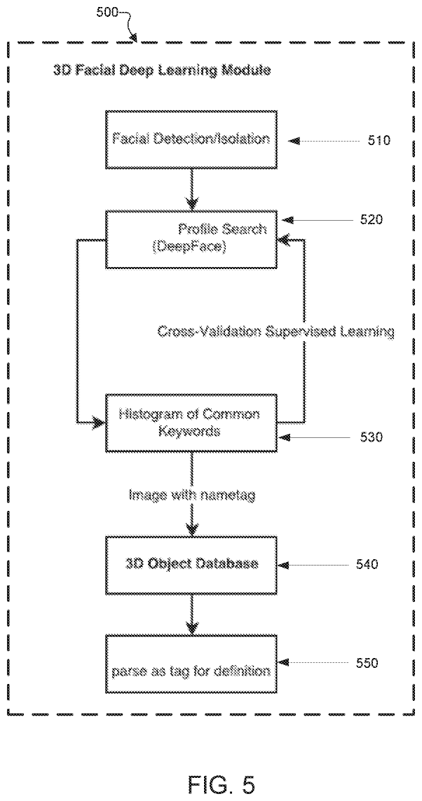

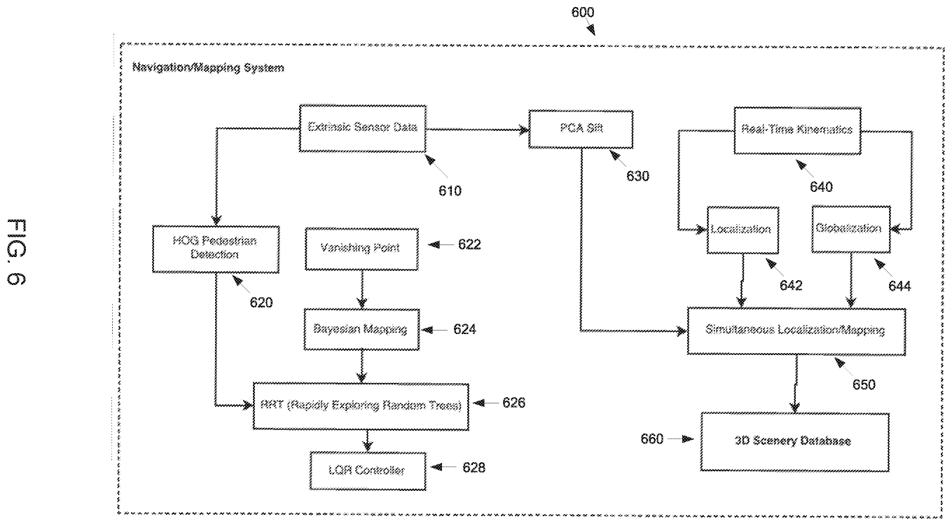

In operation 360, the system 300 utilizes a three-dimensional facial deep learning module, for example the three-dimensional facial deep learning module 500 shown in FIG. 5 below. An example of the three-dimensional facial deep-learning module 500 is shown in greater detail below.

In certain embodiments, the object/facial recognition system 300 utilizes video acquisition and three-dimensional object/facial learning to identify objects or faces. For example, the object/facial recognition system may be implemented by hardware and/or software on the mobile platform 105 as well as possibly in communication with server 104. In these embodiments, the object/facial recognition system 300 utilizes video acquisition and three-dimensional object/facial learning to identify objects or faces.

Although FIG. 3 illustrates one example of an object/facial recognition system 300, various changes may be made to FIG. 3. For example, although depicted herein as a series of steps, various steps of system 300 could overlap, occur in parallel, occur in a different order, or occur multiple times.

FIG. 4 illustrates a three-dimensional object deep learning module 400 that can be utilized in an object/facial recognition system in accordance with an embodiment of the present disclosure. In certain embodiments, the three-dimensional object deep learning module 400 may be utilized in object/facial recognition system 300. For example, the module 400 by be implemented by the mobile platform 105 and/or the server 104. The embodiment of the three-dimensional object deep learning module 400 shown in FIG. 4 is for illustration only. Other embodiments of the three-dimensional object deep learning module 400 could be used without departing from the scope of this disclosure.

In operation 410, the module 400 isolates rigid structures from the acquired video 310 to identify specific objects captured in the acquired video 310. In certain embodiments, each isolated object is categorized as an individual image, which can then be processed. In certain embodiments, the rigid structure isolation of operation 410 is the rigid structure isolation of operation 340.

In operation 420, the module 400 utilizes a reverse image search using an image database, such as, for example, Google™ images database. The module 400 performs or requests performance of a reverse search algorithm that searches the processed image on an image database and returns a keyword. The keyword is expressed on one or more pages of results. For example, the keyword may return ten pages of results, although the keyword may return more or less pages of results.

In operation 430, the links expressed on the one or more pages of results are put into a histogram containing common keywords. In certain embodiments, the histogram is created by utilizing unsupervised image recognition through data mining. For example, the module 400 may run a Javascript node. The node uses the frame retrieved and uploads the frame to an image database website, such as, a Google search. The node parses the webpage (html) and finds the proceeding keywords after a best guess. The node then uses the word as a base comparison and searches the next ten pages to find the most common keyword. This data is used to plot the histogram, and the most common keyword is cross checked with the best guess. If they are explicitly the same the image is tagged and placed in a binary tree. This binary tree represents the database, and each image is categorized for faster retrieval, for example, by non-living and living. An image is then retrieved through a camera and is compared for feature analysis and template matching with the image from the database. This is a fast and efficient alternative for image retrieval and classification. One advantage is that the node can use classified objects (images) from the database, but if there is an object the node cannot find the node may use the data mining process to classify the object.

In certain embodiments, the module 400 may utilize cross-validation supervised learning. Cross-validated supervised learning validates the highest number of occurrences of the keyword by searching the keyword to see what image comes up. The image that results is compared with the original image for a resemblance. If the resulting image and the original image contain similar features, the match is verified and the keyword is tagged with the image and stored in the database for objects. This technique is unique and a faster alternative to training datasets, which may take days or weeks.

In certain embodiments, in addition to classifying an object with a name, the result of the search includes an additional tag form that includes a name, definition (e.g., by searching an encyclopedia or dictionary, such as, Webster's dictionary or Wikipedia), three-dimensional object image (as well as metadata), hierarchical species classification (e.g., nonliving, such as, a household item or livings such as, a mammal, a swimming creature), and other descriptive words. In certain embodiments, the additional tag form may be included in the tag of the object's name. In other embodiments, the additional tag form may be tagged onto the object separately from the name tag.

In operation 440, the tagged object is compared to objects contained in a three-dimensional object database. The tagged image with a nametag from operation 430 is tagged with a description, but the image is depicted in two-dimensional form. By comparing the tagged image with objects contained in a three-dimensional object database, the module 400 is able to identify a three-dimensional version of a tagged two-dimensional image in the three-dimensional object database.

In operation 450, the module 400 parses the image's tag for a definition of the object. Once a three-dimensional object is identified in the three-dimensional object database, the module 400 tags the three-dimensional object from the database with the description from the tagged two-dimensional image. In certain embodiments, the tag may include information such as a name, definition (e.g., by searching an encyclopedia or dictionary, such as, Webster's™ dictionary or Wikipedia™), three-dimensional object image (as well as metadata), hierarchical species classification (e.g., nonliving, such as, a household item or livings such as, a mammal), and other descriptive words. Although FIG. 4 illustrates one example of a three-dimensional object deep learning module 400, various changes may be made to FIG. 4. For example, although depicted herein as a series of steps, the steps of module 400 could overlap, occur in parallel, occur in a different order, or occur multiple times.

FIG. 5 illustrates a three-dimensional facial deep learning module 500 that can be utilized in an object/facial recognition system in accordance with an embodiment of the present disclosure. For example, the module 500 by be implemented by the mobile platform 105 and/or the server 104. In certain embodiments, the three-dimensional facial deep learning module 500 may be utilized in object/facial recognition system 300. The embodiment of the three-dimensional facial deep learning module 500 shown in FIG. 5 is for illustration only. Other embodiments of the three-dimensional facial deep learning module 500 could be used without departing from the scope of this disclosure.

In operation 510, the module 500 performs facial detection and isolation from the acquired video 310 to identify specific faces captured in the acquired video 310. In certain embodiments, each isolated face is categorized as an individual image, which can then be processed. In operation 520, the module 500 utilizes DeepFace profile searching. In certain embodiments, DeepFace profile searching may be utilized using a social media website, such as, for example, the Facebook website. However, DeepFace profile searching may be utilized on any index containing faces. In certain embodiments, the module 500 uses PCA Eigenfaces/vectors to detect the faces from the images. PCA is a post processing technique used for dimension reduction. By using PCA, standardized information can be extracted from imagery data regarding human facial features and object features. The use of PCA by the mobile platform 105 reduces the dimensions and allows the focus of image processing to be done on key features. Additional description of face recognition using Eigenfaces is provided in “Face recognition using Eigen Faces,” CVPR by Matthew A. Turk, et al. 1991 which is incorporated by reference herein in its entirety.

In certain embodiments, the faces detected by PCA Eigenfaces/vectors are parsed through a social media website by searching through images that match the image from the facial detection algorithm. In other embodiments, the mobile platform 105 detects an image frame by calculating the distance between the two eyes, mouth, width of the nose, and length of the jaw line. This image may be compared to the face template for frontal, 45°, and profile views to verify if it is a valid face. In certain embodiments, skin tone may also be used to find segments. Skin tone color statistics are very distinctive and may be analyzed to determine if the image is a face. In certain embodiments, the YCbCr color space may be used as most effective for detecting faces.

In operation 530, the links expressed on the one or more pages of results are put into a histogram containing common keywords. In certain embodiments, the histogram is created by utilizing unsupervised image recognition through data mining. For example, running a Javascript node, the node uses the frame retrieved and uploads the frame to an image database website, such as, the Facebook website. The node parses the webpage (html) and finds the proceeding faces after a best guess. The node then uses the face as a base comparison and searches the next ten pages to find the most common face. This data is used to plot the histogram, and the most common face is cross checked with the best guess. If they are explicitly the same, the image is tagged and placed in a binary tree. This binary tree represents the database. An image is then retrieved through a camera and is compared for feature analysis and template matching with the image from the database. This is a fast and efficient alternative for image retrieval and classification. One advantage is that the node can use classified faces from the database, but if there is a face the node cannot find, the node may use the data mining process to classify the face.

In certain embodiments, the module 500 may utilize cross-validation supervised learning. The highest number of occurrences of that one keyword being correlated to the possible keyword is validated by searching that keyword to see what image result is. The image is cross validated with the keyword by entering a search to see if the features in the image match the intended outcome. If the profile the face is on is private, a temporary profile may be created and used to allow the search to be done. As social media privacy rules may change, the face may be tagged in the database and used for facial recognition. In addition to classifying a face with a name, the result of the search may include a tag form that includes a name, description of physical features (e.g., eye color, hair color, etc.), a three-dimensional object image (as well as metadata), and other descriptive words.

In operation 540, the tagged object is compared to objects contained in a three-dimensional object database. The tagged face with a nametag from operation 530 is tagged with a description, but the face is depicted in two-dimensional form. Comparing the tagged face with objects contained in a three-dimensional facial database allows the module 500 to identify a three-dimensional version of a tagged two-dimensional face in the three-dimensional facial database.

In operation 550, the module 500 parses the face's tag for a definition of the face. Once a three-dimensional face is identified the three-dimensional facial database, the module 500 tags the three-dimensional face from the database with the description from the tagged two-dimensional face. In certain embodiments, the tag may include information such as a name, description of physical features (e.g., eye color, hair color, etc.), a three-dimensional object image (as well as metadata), and/or other descriptive words. Although FIG. 5 illustrates one example of a three-dimensional facial deep learning module 500, various changes may be made to FIG. 5. For example, although depicted herein as a series of steps, the steps of module 500 could overlap, occur in parallel, occur in a different order, or occur multiple times.

FIG. 6 illustrates a navigation/mapping system 600 in accordance with an embodiment of the present disclosure. In this embodiment, the navigation/mapping system 600 utilizes sensor data to provide navigation controls. For example, the navigation/mapping system 600 may be implemented by hardware and/or software on the mobile platform 105 as well as possibly in communication with the server 104. The navigation framework provided herein allows the mobile platform 105 to navigate autonomously and efficiently.

In operation 610, extrinsic sensor data is acquired. In certain embodiments, the extrinsic sensor data is acquired by one or more sensors(s) 240 and/or one or more cameras 225. The one or more sensor(s) 240 may be selected from inertial measurement, RGB video, GPS, LIDAR, range finders, sonar, three-dimensional camera data, or any other suitable sensor known to one of ordinary skill in the art. In certain embodiments, the one or more cameras 225 may be any type of camera including, without limitation, three-dimensional cameras or sensors. The extrinsic sensor data may be, for example, imagery and/or sound data.

In some embodiments, the system 600 implements operation 620, a HOG pedestrian detector. A HOG pedestrian detector is a vision based detector that uses non-overlap histograms of an oriented gradient appearance descriptor. The mobile platform 105 uses the HOG pedestrian detector to avoid humans. Example pedestrian detection techniques are further described in “Pedestrian detection: A benchmark,” CVPR by Dollar, et al. 2009 which is incorporated by reference herein in its entirety.

In some embodiments, the system 600 implements operation 622, detecting vanishing points surrounding the mobile platform 105. An example of detecting the vanishing point are further described in “Detecting Vanishing Points using Global Image Context in a Non-Manhattan World,” CVPR by Zhai, et al. 2016 which is incorporated by reference herein in its entirety.

In operation 624, the detection of vanishing points in operation 622 creates a Bayesian map. Using the Monte Carlo Localization (MCL) algorithm through Bayes filter, the mobile platform 105 utilizes created probabilistic maps to globally localize the mobile platform 105 and discover its position. The benefit of using MCL is that no prior information is needed to start. As the mobile platform 105 performs any movements, data is collected and fused to generate a probabilistic map of the mobile platform's 105 surroundings. The Bayes filter is used to account for previous data collected and sensor noise and provides a gradient translation from a history to the most current readings. Example MCL algorithms are further described in “Monte Carlo Localization: Efficient Position Estimation for Mobile Robots,” AAAI by Dieter, et al. 1999 which is incorporated by reference herein in its entirety.

In operation 626, the system 600 incorporates the data from operation 620 HOG pedestrian detection and operation 624 Bayesian mapping to utilize rapidly-exploring random trees (RRT). RRT is an advanced path planning technique that offers better performance over other existing path planning algorithms such as the randomized potential fields and probabilistic roadmap algorithms. RRT provides these advantages because it can account for nonholonomic and holonomic natures of the mobile platform's 105 locomotion. RRT can handle high degrees of freedom for more advanced robotic motion profiles and constructs random paths based on the dynamics model of the robot from the initial point/path. RRT generally favors unexplored areas, but in a consistent and decently predictable manner. RRT is also relatively more trivial to implement than competing algorithms enabling more straightforward analysis of performance. RRT techniques are further described in “Rapidly Exploring Random Trees: A New Tool for Path Planning” Iowa State University by LaValle 1998, incorporated by reference herein in its entirety.

In operation 628, the system 600 utilizes linear quadratic regulation (LQR) by incorporating the constructed random paths of operation 626 RRT. LQR is an optimal controller that establishes a cost function of what the operator of the mobile platform 105 assumes as most important. The mobile platform 105 uses LQR to control height, altitude, position, yaw, pitch and roll. This is empirical when stabilizing the mobile platform 105 as better estimation allows for precise and agile maneuvers.

In some embodiments, the system 600 implements operation 630, PCA SIFT. The scale-invariant feature transformation is implemented by applying a Gaussian Blur that includes four stages of scale-space extrema detection, key-point localization, orientation assignment and key-point descriptor. The algorithm localizes interest points in position and scale. PCA is a technique used for dimensionality which matches key-point patches and allows the image to be implemented by constructing a Gaussian pyramid and searching for local peaks in a set of difference-of-Gaussian (DoG) images to display high dimensional samples into low dimensional feature space. This data may then be implemented in simultaneous localization and mapping 650.

In some embodiments, the system 600 implements operation 640, RTK GPS, which has increased accuracy (e.g., down to centimeter accuracy) since RTK GPS analyzes the GPS satellite signals instead of directly relying on the signals' data content. The system 600 accomplishes this by using two GPS receivers which share signal data with each other at a distance in order to identify the signals' phase differences from their respective locations. Using a mesh network of mobile platforms 105a-n, multiple sources of GPS signal data can be shared between the mobile platforms 105a-n, and thus perform RTK GPS between the mobile platforms 105a-n. In addition, mobile real time kinematic (MRTK) can be used, which is a process where drones share their GPS info to emulate RTK GPS. The data can be further implemented in simultaneous localization and mapping 650.

In operation 642, the system 600 utilizes the signal data obtained in operation 640 to generate a localized map of its surroundings. In operation 644, the system 600 utilizes the signal data obtained in operation 640 to generate a globalized map of its surroundings.

In operation 650, the localization and globalization maps generated in operations 642 and 644 respectively are processed using RGB-D SLAM, which gives the mobile platform 105 the ability to position itself based on the map by using camera and LIDAR input. To implement SLAM, the mobile platform 105 uses sensor inputs, e.g., three-dimensional LIDAR, range finders, sonar, and three-dimensional cameras, to provide an estimation of distance to create a map of an environment while computing the current location in relation to calculate the surrounding environment. It should be noted that although the word simultaneous is used the localization and mapping may occur near simultaneously or sequentially. Using an EKF, sensor data is input and landmark extraction is applied. Then the data is associated by matching the observed landmark with the other sensor data (e.g., three-dimensional LIDAR, range finders, sonar, and three-dimensional cameras). The mobile platform 105 uses the associated data to either create an EKF re-observation or, if that data does not exist, a new observation. The odometry changes and the EKF odometry is updated. The odometry data gives an approximate position of the mobile platform 105. As the mobile platform 105 moves, the process is repeated again with the mobile platform's 105 new position.

Gmaping is the implemented SLAM method of choice as it is an efficient Rao-Blackwellized particle filter to learn grid maps from laser data and stores in an OctoMap. For the planner an A* algorithm could consider the effect of the SLAM uncertainty of the action at a fine granularity. When combined with RRT, the planner mobile platform 105 creates attainable, non-colliding macro actions that explore space of usable solution.

In operation 660, the system 600 inputs the resulting objects from SLAM into a three-dimensional scenery database. In certain embodiments, the three-dimensional scenery database may be included in the three-dimensional object database described in FIG. 4. In other embodiments, the three-dimensional scenery database may be a separate database from the three-dimensional object database described in FIG. 4, but functions in the same way. Although FIG. 6 illustrates one example of navigation/mapping system 600, various changes may be made to FIG. 6. For example, although depicted herein as a series of steps, the steps of system 600 could overlap, occur in parallel, occur in a different order, or occur multiple times.

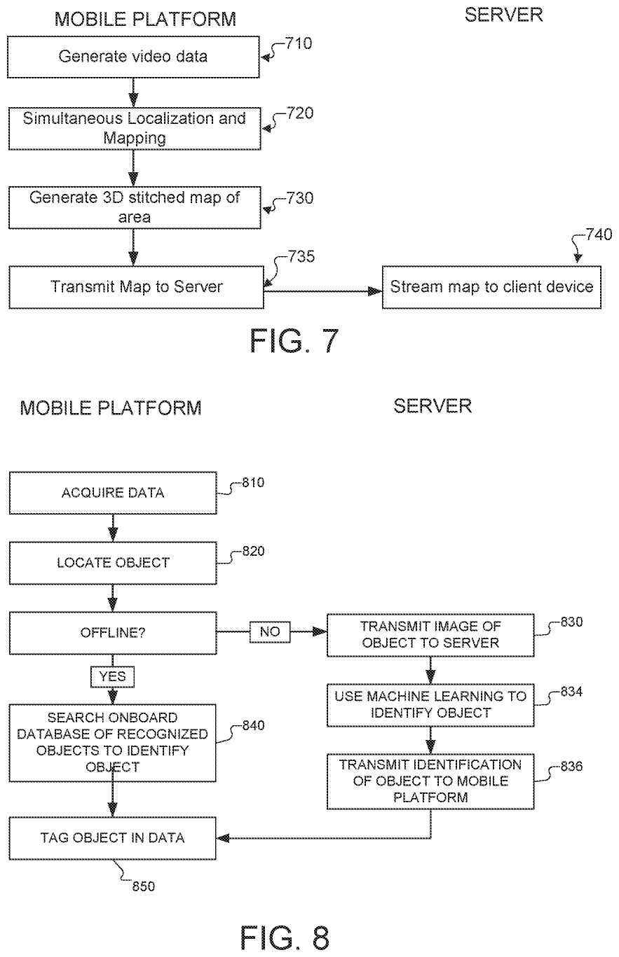

FIG. 7 illustrates an example process for navigating and mapping an area according to various embodiments of the present disclosure. For example, the process depicted in FIG. 7 could be performed by various embodiments of the present disclosure, such as the server 104 or the mobile platform 105. In various embodiments, the process may be performed by one or more mobile platforms 105 simultaneously.

In operation 710, the mobile platform 105 generates video data of an area. In certain embodiments, the mobile platform 105 may use the navigation/mapping system 600 to determine a navigation path of a specified area. In certain embodiments, the mobile platform 105 may utilize rapidly-exploring random trees (RRT) to construct a navigation of a specified area. The embodiments specified should not be construed as limiting. Any method known to one of ordinary skill in the art may be used to determine a navigation path.

As the mobile platform 105 travels along its navigation path, the mobile platform 105 collects and generates extrinsic and intrinsic sensor data using one or more sensor(s) 240 and/or one or more cameras 225. In certain embodiments, the one or more sensors(s) 240 may be selected from inertial measurement, RGB video, GPS, LIDAR, range finders, sonar, three-dimensional camera data, or any other suitable sensor known to one of ordinary skill in the art. In certain embodiments, the one or more cameras 225 may be any type of camera including, without limitation, three-dimensional cameras or sensors.

In certain embodiments, computer vision is applied to the three-dimensional camera 225 by using the plane filtered point cloud. Monte Carlo Localization and Corrective Gradient Refinement is the technique whereby the map/image is in two dimensions, and the three-dimensional point cloud image and the plane normals are displayed on the two-dimensional image with the corresponding normals to create a two-dimensional point cloud image. To navigate autonomously, the mobile platform 105 needs to detect and avoid obstacles, which may be accomplished by computing the pen path lengths accessible for different angular directions. In certain embodiments, the check for obstacles is performed using the three-dimensional points from the previous image and the obstacles are detected with the depth image. By autonomously detecting obstacles, the mobile platform 105 is able to localize its position and avoid obstacles. In certain embodiments, there is an offset error and mean angle error, which is why a combination of sensors 240 such as the LIDAR can give pinpoint accuracy when overlaid with the one or more three-dimensional cameras 225. In certain embodiments, the one or more three-dimensional cameras 225 consist of landmark extraction, data association, state estimation, state updates, and landmarks updates. By using a combination of algorithms to give the desired outcome, there is cross validation and fewer errors involved in autonomous navigation.

In operation 720, the mobile platform 105 processes the generated video data using SLAM. In operation 730, the mobile platform 105 generates a three-dimensional stitched map of the area using the results of SLAM. For example, the mobile platform 105 may generate the three-dimensional stitched map by combining the localized and mapped data to render a geo-spatially accurate 3-D model or representation of the area. In certain embodiments, the stitched map of the specified area may be incomplete. If the map is incomplete, the processor 210 onboard the mobile platform 105 sends a signal to the mobile platform 105 containing information regarding which area of the map is incomplete, and directs the mobile platform 105 to generate additional video data of the incomplete area. The mobile platform 105 may be instructed to generate additional video data as many times as is necessary to complete the map.

In operation 735, the mobile platform 105 transmits the completed stitched map to a server, such as server 104 in FIG. 1. For example, the mobile platform 105 may perform compression and may transmit data for the map via a cellular network, such as base station 112 and network 102 in FIG. 1, to the server in real-time or near real-time.

In operation 740, the three-dimensional stitched map of the specified area is streamed to a client device 105-110. For example, an end user can load or log onto an app or website and view the three-dimensional stitched map as it is generated and transmitted from the mobile platform 105. In various embodiments, the stream is transmitted to any or all of a mobile telephone or smartphone 108, laptop computer 110, and/or desktop computer 112.

Although FIG. 7 illustrates one example of a process for navigating and mapping an area, various changes may be made to FIG. 7. For example, although depicted herein as a series of steps, the steps of the process could overlap, occur in parallel, occur in a different order, or occur multiple times.

FIG. 8 illustrates an example process for object recognition according to various embodiments of the present disclosure. For example, the process depicted in process could be performed by the server 104 and/or one or more mobile platforms 105.

In operation 810, the mobile platform 105 acquires data. The mobile platform 105 acquires video data using one or more sensor(s) 240 and/or one or more cameras 225 as it travels along its flight path.

In operation 820, the mobile platform 105 locates an object within the acquired data. In various embodiments, the mobile platform 105 may locate an object by utilizing edge extraction 330, feature extraction 332, and rigid structure isolation 340. In certain embodiments, the object may be a living object, for example a human or dog. In other embodiments, the object may be a non-living object, for example a house, tree, or another mobile platform 105.

In operation 830, if the mobile platform 105 is not offline, the mobile platform 105 transmits an image of the object to the server 104. If the mobile platform 105 is offline, operation 830 is not performed and the mobile platform proceeds to operation 840. The server 104 receives the image transmitted from mobile platform 105, and in operation 834 the server 104 utilizes machine learning to identify the object. In certain embodiments, the server 104 may utilize one or more aspects of object/facial recognition system 300, three-dimensional object deep learning module 400, and/or three-dimensional facial deep learning module 500 to identify the object. For example, the use of machine learning to identify the object may include three-dimensional object deep learning module 400 to identify an object. The use of machine learning to identify the object may include three-dimensional facial deep learning module 500 to identify an object if the object is recognized as a face. In operation 836, the server 104 transmits the identification of the object to the mobile platform 105.

Although depicted herein as being performed by the server 104, these embodiments should not be construed as limiting. The mobile platform 105 is capable of performing operation 834 using its onboard processor 210. For example, even if the mobile platform 105 is not offline, the mobile platform 105 may access an online database of images to utilize machine learning to perform object recognition via its onboard processor 210.

If the mobile platform is offline, the mobile platform 105 performs operation 840. In certain embodiments, the mobile platform 105's memory 230 may contain a local database of objects and/or a database of faces. In operation 840, the mobile platform 105 searches the memory 230's local database to identify the object. The mobile platform 105 scans the database of objects and/or the database of faces for an image similar to the located object. Once an image is recognized, the mobile platform 105 identifies the object as the image housed in the database. For example, the mobile platform 105 can perform the object recognition on-board without using the transceiver.

In operation 850, the mobile platform 105 tags the object in the acquired data with the identification of the image. In certain embodiments, the identification is received from the server 104, for example when the mobile platform is not offline. In other embodiments, the identification is received from the memory 230 of the mobile platform 105. The tagged information may include, but is not limited to, any or all of the object's name, definition, three-dimensional object image (as well as metadata), hierarchical species classification (e.g., nonliving, such as, a household item or livings such as, a mammal or a swimming creature), and other descriptive words. Although FIG. 8 illustrates an example process of machine learning, various changes may be made to FIG. 8. For example, although depicted herein as a series of steps, the steps of process could overlap, occur in parallel, occur in a different order, or occur multiple times.

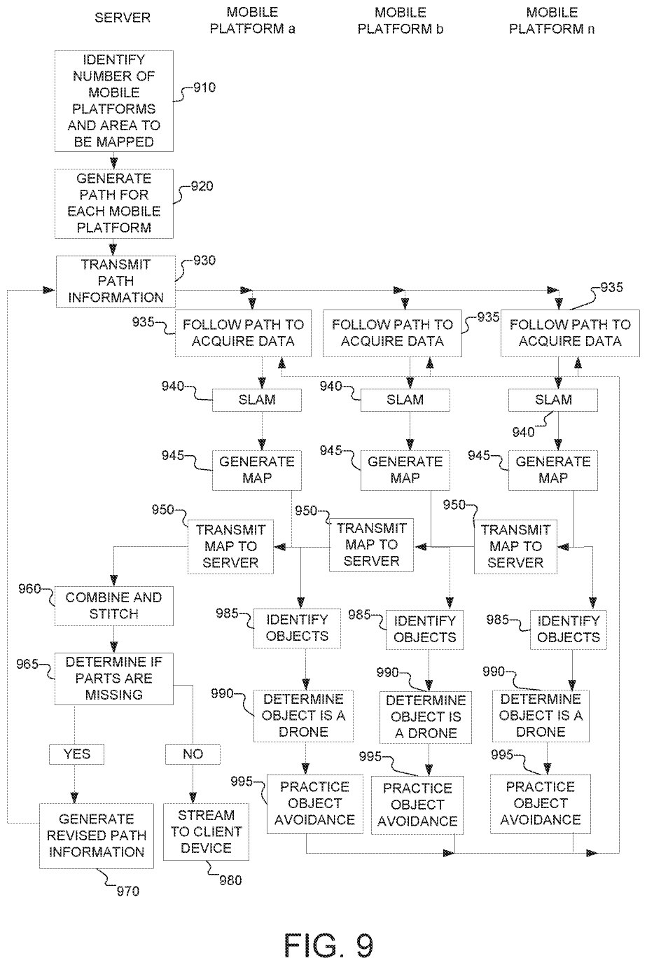

FIG. 9 illustrates an example process for swarming according to various embodiments of the present disclosure. For example, the process depicted in FIG. 9 could be performed by the server 104 and/or one of more mobile platforms 105.

In operation 910, the server 104 identifies an area to be mapped and the number of mobile platforms 105 to be used to map the area. The server 104 may identify the area to be mapped using GPS coordinates, physical landmarks (e.g., an area with corners defined by three or more landmarks), or any other suitable means. In certain embodiments, the server 104 may identify one or more mobile platforms 105 to map the area. For example, the server 104 may identify multiple mobile platforms 105 to be used if the area to be mapped is geographically large or contains a high volume of traffic. If an area is geographically large, utilizing a greater number of mobile platforms 105 decreases the amount of time it will take to map the area. If an area contains a high volume of traffic, the mobile platforms 105 may need to maneuver more slowly to avoid the higher amount of obstacles. In this case, even though an area to be mapped may not be geographically large, a single mobile platform 105 may take a longer time to map the entire area. These embodiments should not be construed as limiting. The server 104 may identify any number of mobile platforms 105 to be used to map an area of any size for any number of reasons.

In operation 920, the server 104 generates a path for each mobile platform 105. In certain embodiments, the server 104 designates a different mobile platform 105 to map each different sections of the area to be mapped. By generating a different path for each mobile platform 105 based on the section of the map the specific mobile platform 105 is assigned, the server 104 distributes the mobile platforms 105 throughout the area to be mapped in the most efficient way possible. For example, by generating a different path for each mobile platform 105, the server 104 decreases the potential for the overlap of data acquired by each mobile platform 105, decreases the amount of time required to map an area, and decreases the likelihood of mobile platforms 105 colliding with one another or other obstacles. Other advantages may also be apparent to one of ordinary skill in the art.

In operation 930, the server 104 transmits the path information generated in operation 920 to the one or more mobile platforms 105. Transmitting the path information to the one or more mobile platforms 105 provides special guidance to the one or more mobile platforms 105 regarding the best approach to map the area and acquire data. In various embodiments, the path information may include a specific area to be mapped with boundaries defined by GPS coordinates or physical landmarks, a general area to be mapped, specific step by step turn instructions, or any other information sufficient to communicate to each mobile platform 105 the path it is to follow.

In operation 932, each mobile platform 105 follows the path received from the server 104. As each mobile platform 105 travels along its specified navigation paths, it generates video data using one or more sensor(s) 240 and/or one or more cameras 225. In operation 934, each mobile platform 105 performs SLAM using the data acquired in operation 932.

In operation 936, each mobile platform 105 generates a three-dimensionally stitched map of its specified area using the results of SLAM. For example, the mobile platform 105 may generate the three-dimensional stitched map as discussed above in FIG. 7. In operation 938 each mobile platform 105 transmits its three-dimensionally stitched map to the server 104. Although depicted herein as a series of steps, operations 932-938 may be performed in parallel, performed in a different order, or performed multiple times. In various embodiments, operations 932-938 occur simultaneously. As each mobile platform 105 acquires data, SLAM may be performed on the acquired data in real time. As SLAM is performed, each mobile platform 105 may generate its three-dimensional stitched map in real time so each map is continuously updated. As each map is generated, each mobile platform 105 may transmit its map to the server 104 in real time. By performing operations 932-938 simultaneously, the process is completed in a timely and efficient manner.

In operation 940, the server 104 combines and stitches together the maps received from each mobile platform 105 into a global, three-dimensionally stitched map. As the server 104 receives the maps from each mobile platform 105, the server 104 compares the path information transmitted to each mobile platform 105 in operation 930 to the map received to determine where on the global map the received map should be stitched. For example, the server 104 recognizes which map is received from mobile platform 105a. The server 104 compares this map to the path information transmitted to mobile platform 105a, and stitches the received map into the proper position on the global map.

In operation 950, the server 104 determines if the global map contains any holes. A hole in the global map is any area that is not properly stitched together. In various embodiments, a hole may exist in the global map because the mobile platform 105 failed to follow its path correctly, one or more sensors 240 or cameras 225 failed to properly acquire the data, the data may have been compromised during acquisition, SLAM was not successfully performed, the local map was not generated properly, the local map was not transmitted properly, the server 104 provided incomplete or otherwise faulty instructions, the server 104 made an error in stitching the global map, or any other reason.

If the global map contains one or more holes, in operation 960 the server 104 generates revised path information for one or more mobile platforms 105. Revised path information provides instructions to one or more mobile platforms 105 to reacquire data of a particular location or area. In embodiments where parts of the global map are missing and revised path information is generated in operation 960, the revised path information is re-transmitted to the one or more mobile platforms 105 following the procedure in operation 930. At this point, operations 930 through 960 are performed until the global map is completed and does not contain any holes.

In certain embodiments, the server 104 generates revised path information for more than one mobile platform 105 based on a single hole in the global map. For example, the server 104 recognizes that although a hole was originally within the section of the map transmitted to mobile platform 105a, mobile platform 105b is closer to the hole at a specific moment or is on a current trajectory in the direction of the hole. For either of the above reasons, or any other reason, the server determines the path information of mobile platform 105b, rather than mobile platform 105a, should be revised to fill the hole in the global map. In this embodiment, the server 104 generates and transmits revised path information to mobile platform 105b.

When the global map is completed and does not contain any holes, the server 104 streams the global map to a client device 108-112 in operation 970. For example, in various embodiments, the stream may be transmitted to any or all of a mobile telephone or smartphone 108, laptop computer 110, and/or desktop computer 112. Although depicted herein as separate steps, in various embodiments operations 950 and 960 may occur in parallel. For example, the server 104 may stream the global map to a client device 108-112 in real time as the global map is being stitched.

In various embodiments, each mobile platform 105 utilizes data from the local map generated in operation 936 to avoid colliding with other objects. In operation 985, a mobile platform 105 identifies a surrounding object. As the object is identified on the generated map, the mobile platform 105 determines the object's location relative to the location of the mobile platform 105. For example, the mobile platform 105a recognizes its own location and identifies a surrounding object 90 feet to the north and 50 feet above the mobile platform 105.

In operation 990, the mobile platform 105, for example mobile platform 105a, identifies the surrounding object as another mobile platform 105, for example mobile platform 105n. In certain embodiments, the mobile platform 105 may determine a surrounding object as another mobile platform 105 by searching an object database on the mobile platform 105's memory 230. In other embodiments, the server 104 may recognize the relative proximity of two mobile platforms 105 and transmit a signal to mobile platform 105a alerting it to the proximity of mobile platform 105n, and transmit a signal to mobile platform 105n alerting it to the proximity of mobile platform 105a.

In operation 995, the mobile platform 105 practices object avoidance. When practicing object avoidance, the mobile platform 105a adjusts its current trajectory in a manner to avoid making contact with the identified mobile platform 105n. In various embodiments, the mobile platform 105a may practice object avoidance by continuing on its current path but coming to a stop until the other mobile platform 105 has cleared the area, by altering its path to avoid the other mobile platform 105n, by signaling to the other mobile platform 105n to alter its flight path, and/or any other suitable means. In certain embodiments, operation 995 may involve altering the flight path of mobile platform 105. In these embodiments, after the mobile platform 105a has successfully avoided the other mobile platform 105n, the mobile platform 105a redirects its path to follow the initial path to acquire data in operation 932. From there, the process continues with acquiring data, performing SLAM, generating the map, etc. Although FIG. 9 illustrates one example of a process for swarming, various changes may be made to FIG. 9. For example, although depicted herein as a series of steps, the steps of process could overlap, occur in parallel, occur in a different order, or occur multiple times.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions a\and embodiments described herein can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

1. A method for stitching video data in three dimensions, the method comprising:
generating video data including multiple viewpoints of objects in an area using at least one camera mounted on a drone;
localizing and mapping, by at least one processor on the drone, the video data including the multiple viewpoints;
generating a three-dimensional stitched map of the area using the localized and mapped video data; and
wirelessly transmitting, by a transceiver on the drone, data for the stitched map.

2. The method of claim 1, further comprising:
identifying one or more of the objects in the generated video data;
comparing image data, from the generated video data, of at least one of the one or more identified objects to object image data stored in a database;
identifying a type of the one identified object based on the comparing; and
including information about the identified type of the one identified object in the stitched map in a location proximate the one identified object.

3. The method of claim 2, wherein:
the drone includes a memory configured to store the database on board the drone, and
identifying a type of the one identified object comprises identifying the type of the one identified object by searching the memory without using the transceiver.

4. The method of claim 2, wherein:
the database is an internet connected database, and
comparing the image data of at least one of the identified objects to the object image data stored in the database comprises performing, using the transceiver, a search of the internet connected database to identify the type of the one identified object.

5. The method of claim 1, further comprising compressing, by the at least one processor on the drone, the data for the stitched map,
wherein transmitting the data for the stitched map comprises transmitting, by the transceiver, the compressed data to a server for real-time streaming to a client device.

6. The method of claim 1, further comprising receiving path planning data from a server, wherein:
generating the video data comprises generating the video data based on received the path planning data, and
the drone is one of a plurality of drones generating the video data of the area.

7. The method of claim 6, further comprising:
identifying one or more other drones in the plurality of drones and a location of the one or more other drones relative to the drone by comparing image data, from the generated video data, of the one or more other drones to object image data stored in a database;
monitoring the location of the one or more other drones relative to the drone;
practicing obstacle avoidance of the one or more other drones based on the monitored location; and
including and dynamically updating the location of the one or more other drones in the stitched map that is transmitted to the server.

8. A drone comprising:
a camera configured to generate video data including multiple viewpoints of objects in an area;
at least one processor operably connected to the camera, the at least one processor configured to:
localize and map the video data including the multiple viewpoints; and
generate a three-dimensional stitched map of the area using the localized and mapped video data; and
a transceiver operably connected to the at least one processor, the transceiver configured to wirelessly transmit data for the stitched map.

9. The drone of claim 8, wherein the at least one processor is further configured to:
identify one or more of the objects in the generated video data;
compare image data, from the generated video data, of at least one of the one or more identified objects to object image data stored in a database;
identify a type of the one identified object based on the comparison; and
include information about the identified type of the one identified object in the stitched map in a location proximate the one identified object.

10. The drone of claim 9, further comprising:
a memory configured to store the database on board the drone,
wherein the at least one processor is further configured to identify the type of the one identified object by searching the memory without using the transceiver.

11. The drone of claim 9, wherein:
the database is an internet connected database, and
the at least one processor is further configured to perform, using the transceiver, a search of the internet connected database to identify the type of the one identified object.

12. The drone of claim 8, wherein:
the at least one processor is further configured to compress the data for the stitched map, and
the transceiver is further configured to transmit the compressed data to a server for real-time streaming to a client device.

13. The drone of claim 8, wherein:
the transceiver is further configured to receiving path planning data from a server;
the at least one processor is further configured to generate the video data based on received the path planning data; and
the drone is one of a plurality of drones generating the video data of the area.

14. The drone of claim 13, wherein the at least one processor is further configured to:
identify one or more other drones in the plurality of drones and a location of the one or more other drones relative to the drone by comparing image data, from the generated video data, of the one or more other drones to object image data stored in a database,
monitor the location of the one or more other drones relative to the drone, and control a motor of the drone to practice obstacle avoidance of the one or more other drones based on the monitored location.

15. The drone of claim 14, wherein the at least one processor is further configured to include and dynamically update the location of the one or more other drones in the stitched map that is transmitted to the server.
